(19) United States
(12) Patent Application Publication
(10) Pub. No.: US 2025/0356202 A1
(43) Pub. Date: Nov. 20, 2025

(54) LARGE LANGUAGE MODEL-GUIDED TRAINING DATA SELECTION

(71) Applicant: Apple Inc., Cupertino, CA (US)

(72) Inventors: Xiang KONG, Santa Clara, CA (US); Ruoming PANG, New York, NY (US); Thomas B. GUNTER, Menlo Park, CA (US)

(21) Appl. No.: 19/069,210

(22) Filed: Mar. 3, 2025

Related U.S. Application Data
(60) Provisional application No. 63/647,552, filed on May 14, 2024.

(51) Int. Cl. G06N 3/09; G06N 3/045; G06N 3/096

(52) U.S. Cl. CPC G06N 3/09; G06N 3/045; G06N 3/096

(57) ABSTRACT

The subject technology provides for large language model-guided training data selection. An apparatus provides a plurality of data items from a first corpus of data to a first trained machine learning model. The apparatus generates, using the first trained machine learning model, a labeled dataset comprising a tag for each data item of the plurality of data items, in which the tag indicates a quality assessment of the data item. The apparatus adjusts one or more parameters of a second trained machine learning model using tagged data items from the labeled dataset. The apparatus generates a second corpus of data by processing one or more data items of the first corpus of data through the second trained machine learning model. The apparatus can produce one or more trained machine learning models by training one or more neural networks with the second corpus of data.

### CROSS-REFERENCE TO RELATED APPLICATION(S)

This application claims the benefit of U.S. Provisional Application Ser. No. 63/647,552, entitled “LARGE LANGUAGE MODEL-GUIDED TRAINING DATA SELECTION,” and filed on May 14, 2024, the disclosure of which is expressly incorporated by reference herein in its entirety.

### TECHNICAL FIELD

The present description generally relates to large language model-guided training data selection.

### BACKGROUND

Machine learning has seen a significant rise in popularity in recent years due to the availability of training data, and advances in more powerful and efficient computing hardware. Machine learning may utilize models that are executed to provide predictions in particular applications. Large language models are characterized by their substantial size, often comprising hundreds of millions to billions of parameters. These models require significant computational power and memory for training and inference. The vast number of parameters allows them to capture complex linguistic patterns and generate coherent and contextually relevant text, making them powerful tools in natural language processing tasks. However, training these large language models presents challenges related to model performance.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for a system providing machine learning models, in accordance with one or more implementations.

FIG. 3 is a flow chart of an example process that may be performed for large language model-guided training data selection in accordance with one or more implementations.

FIG. 4 conceptually illustrates an example overview of large language model-guided training data selection in accordance with one or more implementations.

FIG. 5 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Advancements in artificial intelligence (AI) have led to the deployment of end-user-interfacing systems. These advancements in AI have been notable, particularly due to the significant progress in large language models (LLMs). These models, characterized by their vast capacity and billions of parameters, have shown capabilities in tasks such as language understanding, reasoning, and generation. Conversational assistants leverage downstream LLMs for various tasks. LLMs have garnered attention due to their high performance in various natural language understanding and generation tasks, along with emerging capabilities not found in smaller models. A base LLM can be deployed to support various downstream tasks such as summarization, classification and chat assistance via a task-specific adapter module. Their success can be attributed not only to their immense size but also to the extensive corpora used for their training, often sourced from diverse web repositories, which contain large volumes of unlabeled and raw data collected from various snapshots of the Internet. In contrast to small, domain-specific datasets, which offer high-quality data within their respective domains, large-scale web corpora provide a wealth of knowledge that could potentially enhance the performance of LLMs. However, not all information available on the web contributes equally to effective model training, and the quality of documents can vary significantly. In this regard, indiscriminate training on all available data may not yield optimal results due to differing quality levels among sources of this data. Hence, data curation can improve training data quality and potentially achieve a better balance between model quality and required training. For example, the curated data should include data that possesses both high quality and educational value. However, determining and selecting high-quality data from such vast datasets presents a significant challenge. This challenge involves various factors, including assessing the reliability, relevance, and coherence of the data, as well as considering potential biases and inaccuracies inherent in web-derived content.

Embodiments of the subject technology provide for a framework that includes an LLM-guided training data selection pipeline that utilizes zero-shot textual comprehension and reasoning abilities of LLMs to autonomously evaluate and select high-quality textual data. The framework can employ two LLMs of different scales: a larger model (referred to hereinafter as “LMlarge”) for precise data quality assessment on a small sample of documents from the raw corpus, and a smaller, more computationally efficient model (referred to hereinafter as “LMsmall”) fine-tuned on data generated by the larger model to label the entire raw corpus. The LLM-guided training data selection pipeline can demonstrate significant enhancements in model performance across various downstream tasks. The LLM-guided training data selection pipeline of the present disclosure provides for a strategic, model-informed data selection for effectively training LLMs, offering opportunities for conserving resources and improving model performance in large-scale language model applications.

Embodiments of the subject technology provide for large language model-guided training data selection. An apparatus provides a plurality of data items from a first corpus of data to a first trained machine learning model. The apparatus generates, using the first trained machine learning model, a labeled dataset comprising a tag for each data item of the plurality of data items, in which the tag indicates a quality assessment of the data item with regard to a quality of the data item as training data. The apparatus adjusts one or more parameters of a second trained machine learning model using tagged data items from the labeled dataset. The apparatus generates a second corpus of data by processing one or more data items of the first corpus of data through the second trained machine learning model. The apparatus can produce one or more trained machine learning models by training one or more neural networks with the second corpus of data.

Implementations of the subject technology improve the ability of a given electronic device to provide machine-learning generated data to a user (e.g., a user of the given electronic device). Furthermore, implementations of the subject technology improve the quality of a machine learning model by training the model with a large language model-guided selection of training data. These benefits therefore are understood as improving the computing functionality of a given electronic device, such as an end user device which may generally have less computational and/or power resources available than, e.g., one or more cloud-based servers.

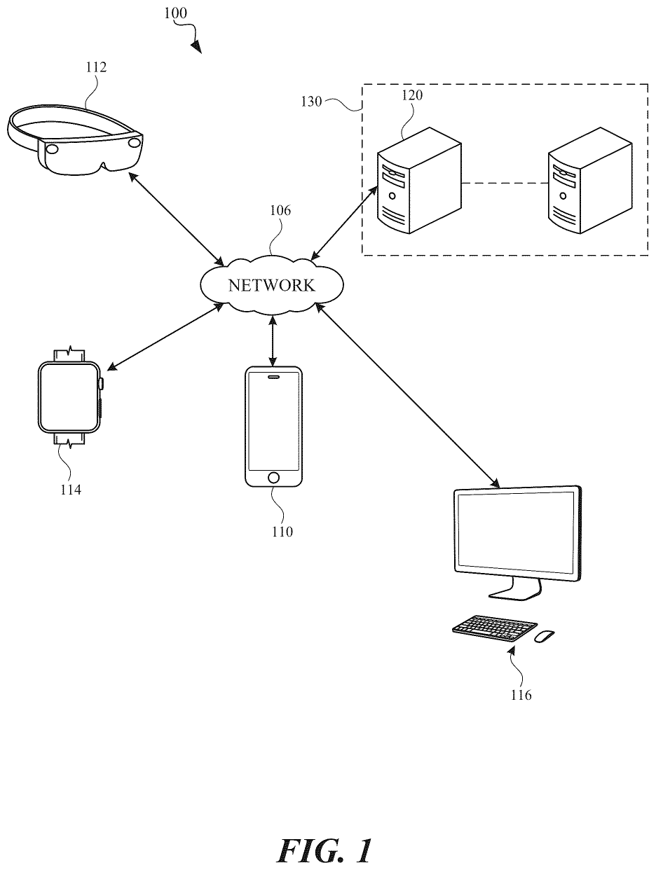

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, and the server 120; however, the network environment 100 may include any number of electronic devices and any number of servers or a data center including multiple servers.

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

The electronic device 112 may be, for example, desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 7.

The electronic device 114 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 7.

The electronic device 116 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 7.

In one or more implementations, one or more of the electronic devices 110-116 may provide a system for training a machine learning model using training data, where the trained machine learning model is subsequently deployed to one or more of the electronic devices 110-116. Further, one or more of the electronic devices 110-116 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-116 may be performed entirely on the electronic devices 110-116, to prevent exposure of individually identifiable data to devices and/or systems that are not authorized by the user.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

The server 120 may provide a system for training a machine learning model using training data, where the trained machine learning model is subsequently deployed to the server 120 and/or to one or more of the electronic devices 110-116. In an implementation, the server 120 may train a given machine learning model for deployment to a client electronic device (e.g., the electronic device 110, the electronic device 112, the electronic device 114, the electronic device 116). In one or more implementations, the server 120 may train portions of the machine learning model using (e.g., anonymized) training data from a population of users, and one or more of the electronic devices 110-116 may train portions of the machine learning model using individual training data from the user of the electronic devices 110-116. The machine learning model deployed on the server 120 and/or one or more of the electronic devices 110-116 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

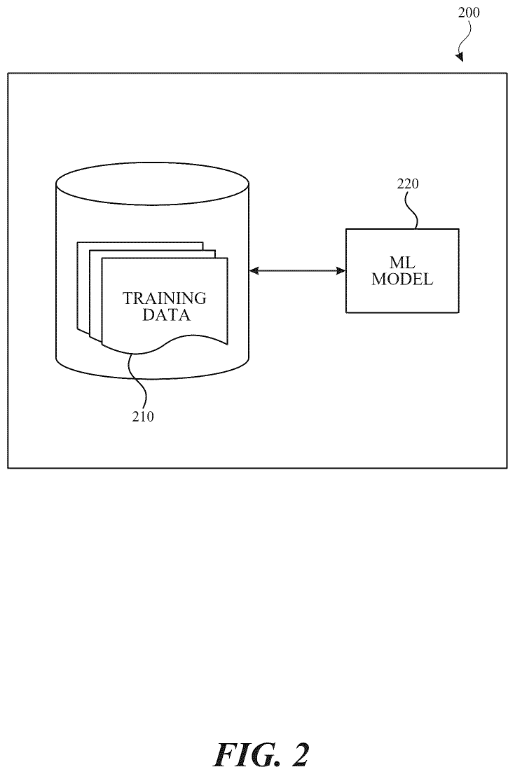

FIG. 2 illustrates an example computing architecture for a system providing machine learning models, in accordance with one or more implementations. For explanatory purposes, the computing architecture is described as being provided by an electronic device 200, such as by a processor and/or memory of the server 120, or by a processor and/or a memory of any other electronic device, such as the electronic device 110. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 200 includes training data 210 for training a machine learning model. In an example, the server 120 may utilize one or more machine learning algorithms that uses training data 210 for training a machine learning (ML) model 220. ML model 220 may include one or more neural networks. In one or more implementations, the ML model 220 is a large language model.

Embodiments of the subject technology address the challenge of data selection for LLMs by utilizing two trained LLMs, LMlarge and LMsmall, each differing in scale, to guide and optimize the data selection process in a two-stage data curation pipeline. In the initial stage, a large model (e.g., LMlarge) evaluates the quality of textual data, which is then refined and utilized to train a smaller model (e.g., LMsmall) in the latter stage. This staged approach can optimize both resource usage and the quality of the data curation process. In one or more implementations, the ML model 220 can correspond to one of the two trained LLMs. In one or more other implementations, the ML model 220 includes both LMlarge and LMsmall. The LMlarge may be a high-capacity instruction-finetuned LLM that includes robust zero-shot textual comprehension, reasoning, and instruction-following abilities for detailed assessment. The LMsmall may be more resource (or computationally) efficient than LMlarge for broader applications. In one or more implementations, the ML model 220 may be implemented as the LMlarge to evaluate a small portion of a raw corpus. Subsequently, the knowledge acquired by LMlarge is transferred to the LMsmall through fine-tuning based on one or more evaluations. In one or more implementations, the ML model 220 may be implemented as the LMsmall to assess all documents within the entire corpus, enabling autonomous evaluation of the complete dataset. This can facilitate efficient and accurate data selection, thereby enhancing the effectiveness of large language models in handling extensive amounts of textual data. The subject technology can leverage the linguistic capabilities inherent in LLMs to independently evaluate the quality and educational value of text, without relying on human-generated labels. For example, by utilizing the robust zero-shot capabilities of the two trained LLMs, the LLM-guided training data selection pipeline can autonomously assess and categorize text data, facilitating the development of more efficient and powerful language models. The subject technology also facilitates the generation of higher-quality training data while simultaneously decreasing the computational burden traditionally associated with training large language models on extensive datasets.

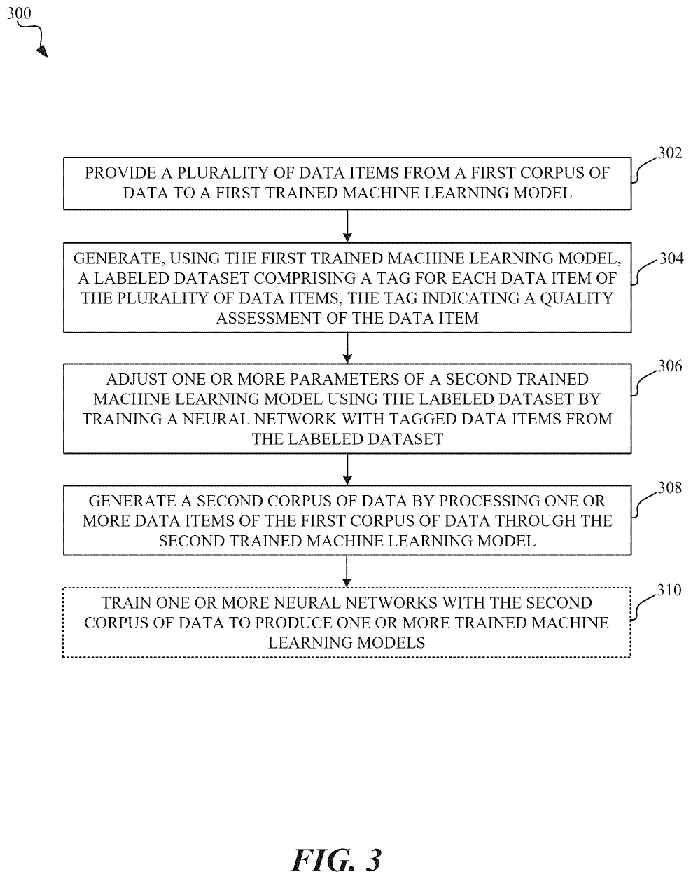

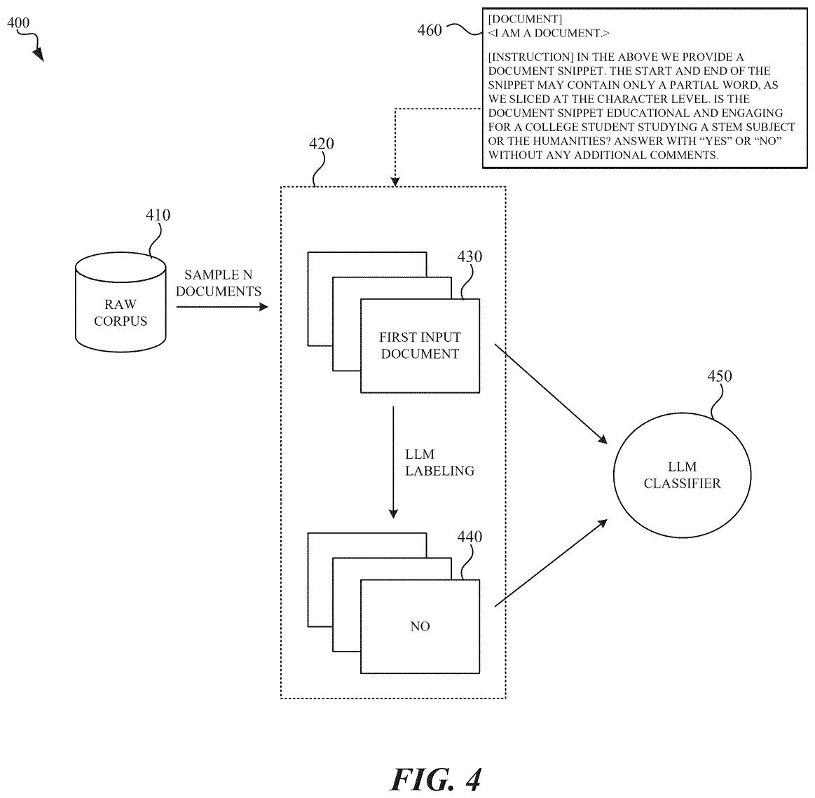

FIG. 3 is a flow chart of an example process that may be performed for large language model-guided training data selection in accordance with one or more implementations. For explanatory purposes, the process 300 is primarily described herein with reference to the electronic device 110 of FIG. 1. However, the process 300 is not limited to the electronic device 110 of FIG. 1, and one or more blocks (or operations) of the process 300 may be performed by one or more other components of other suitable devices and/or servers. Further for explanatory purposes, some of the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations. For purposes of brevity in explanation, aspects of the process 300 will be discussed with reference to FIG. 4.

FIG. 4 conceptually illustrates an example overview of large language model-guided training data selection in accordance with one or more implementations. As illustrated in FIG. 4, an LLM-guided training data selection pipeline 400 includes two primary components. The first component is a raw corpus 410, which may include a dataset upon which the selection process is based. The second component is an instruction-finetuned LLM (e.g., LMlarge 420), which may be a large-scale language model fine-tuned to follow specific directives. The LMlarge 420 can facilitate guiding the data selection process according to predefined instructions, leveraging its linguistic capabilities to evaluate and categorize textual data within the raw corpus 410. In one or more implementations, the combination of the raw corpus 410 and the LMlarge 420 can form a systematic approach to autonomously select and assess data, contributing to the enhancement of large language models' performance and efficiency in handling vast amounts of textual data.

As illustrated in FIG. 3, at block 302, an apparatus (e.g., electronic device 110, 112, 114, 116; ML model 220; processing unit(s) 512) can provide a plurality of data items from a first corpus of data to a first trained machine learning model. In one or more implementations, the subject technology involves an LLM-scraping phase, where data or information can be extracted from the input documents using an advanced language model. The raw corpus 410 may include a set number of documents (N) that is sampled and processed by the LMlarge 420.

In one or more implementations, the raw corpus 410 may undergo one or more preprocessing techniques. For example, deduplication may be carried out at the paragraph level, and a linear classifier can be utilized to filter out low-quality text by categorizing paragraphs as either data references or random data samples. The resulting dataset of the raw corpus 410 may include about 878 billion tokens, for example.

In the LLM-scraping phase, the LMlarge 420 may be implemented as a LLama-2-chat model with a size of about 70 billion parameters. This model may perform robust textual comprehension and reasoning tasks. In one or more other implementations, the LMlarge 420 may be implemented as a Llama-2-chat model with a size of about 7 billion parameters. In the LLM-scraping phase, about two million documents may be sampled from the raw corpus 410. In one or more implementations, this subset of documents from the raw corpus 410 can be initially selected randomly and provided to the LMlarge 420. In one or more implementations, the central 1,500 tokens of each input document 430 are inputted into the LMlarge 420 for quality assessment.

At block 304, the apparatus can generate, using the first trained machine learning model, a labeled dataset comprising a tag for each data item of the plurality of data items. In one or more implementations, the tag indicates a textual quality assessment of the data item. The LMlarge 420 can evaluate these sampled N documents based on predefined criteria. The LMlarge 420 may perform the assessment by examining each input document 430 and determining, based on the predefined criteria, whether the input document 430 meets (or satisfies) the predefined criteria for high textual quality (positive sample) or not (negative sample). For example, the LMlarge 420 may assess each input document and categorize the input document as either a high textual quality document or low textual quality document.

The process includes presenting a prompt 460 to the LMlarge 420 to evaluate the textual quality and educational value of the sampled documents, as depicted in FIG. 4. In one or more implementations, the prompt 460 can be used to perform an assessment of an input document (e.g., input documents 430) and obtain a textual quality and educational value for the input document 430. The prompt 460 can serve as an instruction or a query to the LMlarge 420, which can then evaluate a given sample document based on predefined criteria or directives. The assessment conducted by the LMlarge 420 can involve various linguistic analyses and comparisons to determine the quality and educational value of the input document. In one or more implementations, the LMlarge 420 can generate one or more responses or scores indicating its judgment of the document's quality and educational relevance (e.g., labeled results 440). In one or more implementations, the LMlarge 420 can perform LLM labeling on the input document 430 (e.g., first input document) to generate a labeled result 440 (e.g., “No”).

At block 306, the apparatus can adjust one or more parameters of a second trained machine learning model (e.g., LMsmall 450) using tagged data items from the labeled dataset. In one or more implementations, the subject technology involves an LLM-refinement phase, where the LMsmall 450 is fine-tuned using the high-quality textual samples identified by the LMlarge 420. The LLM-refinement phase can facilitate the transfer of the capability of discernment from the larger model (e.g., LMlarge 420) to the LMsmall 450, enhancing its ability to evaluate textual quality more efficiently. For example, training a language model-based document quality assessor that can label all documents in the raw corpus 410.

In the LLM-refinement phase, the LMsmall 450 may be implemented as a language model with a size of about 302 million parameters. The LMsmall 450 may undergo initial training utilizing higher quality components extracted from an Internet dataset (e.g., Wikipedia). Following the initial training, the LMsmall 450 can be fine-tuned using data obtained from the LLM-scraping phase. For example, one or more input documents 430 and one or more labeled results 440 can be provided to the LMsmall 450 to fine tune the LMsmall 450. In one or more implementations, the LMsmall 450 may be integrated with a distinct classification head, utilizing a resulting feature representation for final prediction. In one or more implementations, outputs from the LMsmall 450 can be normalized between 0 and 1 utilizing a sigmoid function.

In one or more implementations, the labeled results 440, represented as pairs of sampled documents and corresponding assessment labels, can be utilized to construct the LMsmall 450 (e.g., a classifier). Once the classifier is obtained, it can be applied to label all documents within the raw corpus 410 according to their assessed textual qualities and educational relevance. In one or more implementations, the LLM-guided training data selection pipeline 400 illustrated in FIG. 4 can streamline the process of data selection by automating the assessment of documents, thus facilitating the classification of the entire corpus based on predetermined criteria.

The impact of the LMsmall 450 can be evaluated concerning its role in labeling the raw corpus 410 for assessment quality. While one approach can involve using the largest language model with the strongest textual comprehension and reasoning capabilities, practical considerations such as inference inefficiency and the size of the raw corpus 410 provide for a middle-sized language model to balance labeling quality and inference efficiency. In one or more implementations, classifiers of three sizes (e.g., 85 million parameters, 302 million parameters, and 1 billion parameters) are selected, and models are trained on data derived from these classifiers. The F1 score on the evaluation set is compared, revealing that larger classifier models tend to yield higher F1 scores, suggesting that models with greater capability can better learn from the results generated by the LMlarge 420. Similarly, across downstream tasks, larger assessors can demonstrate superior performance. Therefore, these findings suggest that the F1 score serves as a reliable indicator for predicting downstream task accuracy.

Embodiments of the subject technology can provide for autonomous selection of high-quality training data for LLMs by utilizing the LLM-guided training data selection pipeline 400. The subject technology can leverage the capabilities of LLMs while addressing the challenge of obtaining extensive amounts of curated data for training language models. In one or more other implementations, data curated using the LLM-guided training data selection pipeline 400 notably improves model performance across various natural language processing (NLP) tasks compared to data curated through traditional, less automated methods.

Models trained on data selected through the LLM-guided training data selection pipeline 400 can outperform those trained on raw datasets, indicating the high quality and relevance of the selected documents. As a result, it reduces the computational resources and environmental impact associated with training large language models. The exploration of various thresholds for data selection and different model scales offers insights into optimizing the data curation process for diverse applications and data sizes.

By incorporating both the LMsmall 450 and the LMlarge 420 into the LLM-guided training data selection pipeline 400, computational efficiency can be balanced with evaluative performance. In one or more implementations, the LMlarge 420 may be employed for its advanced ability to comprehend and evaluate extensive and intricate textual material. Its instruction-finetuned architecture can enable nuanced and context-sensitive assessments. However, due to the potentially immense size of the raw corpus 410, employing the LMlarge 420 alone for all evaluations becomes impractical from a computational standpoint. In one or more implementations, the LMsmall 450 can provide enhanced computational efficiency, rendering it suitable for applications at scale. Through training the LMsmall 450 with the distilled knowledge from the LMlarge 420 by way of the labeled results 440 and input documents 430, the LLM-guided training data selection pipeline 400 can be both efficient and effective, striking a balance between accuracy and practical utility. Therefore, integrating the LMsmall 450 alongside the LMlarge 420 allows for more efficient processing without compromising evaluative quality while accommodating the scalability required to manage large datasets effectively.

At block 308, the apparatus can generate a second corpus of data by processing one or more data items of the first corpus of data through the second trained machine learning model. In one or more implementations, the second corpus of data is a curated version of the first corpus of data.

In one or more other implementations, various cut-off thresholds on model quality can be implemented using the finetuned LMsmall 450 to label the raw corpus 410. Each document in the raw corpus 410 can be assigned a score in a range of 0 to 1. In one or more other implementations, different cut-off thresholds can be implemented to obtain various dataset retention ratios. For example, setting a cut-off threshold at 0 can retain an entire dataset (e.g., 100% retention ratio), while setting the cut-off threshold at 1 can result in the exclusion of all documents. In one or more implementations, as the dataset retention ratio decreases from 55% to 25%, there may be incremental performance gains, underscoring data quality for downstream task outcomes. However, overly aggressive culling (e.g., reduction from 25% to 15%) can lead to a reduction in performance, suggesting that stringent filtering may reduce the number of potentially valuable documents. In one or more implementations, an optimal dataset retention ratio may vary across datasets.

At block 310, optionally, the apparatus can train one or more neural networks with the second corpus of data to produce one or more trained machine learning models.

To assess the effectiveness of the LLM-guided training data selection pipeline 400, language models of varying scales (e.g., 1 billion parameters and 7 billion parameters) are trained on a subset of high-quality documents determined by scores from the LMsmall 450 (e.g., LM-based classifier). In one or more implementations, a predefined cutoff score (or threshold) can be established, with documents scoring above this threshold used for training, while other documents are discarded. In one or more implementations, one or more of the LLMs (e.g., LMlarge 420, LMsmall 450) are optimized using a stochastic optimization method (e.g., AdamW optimizer) with parameters set to β1=0.9, β2=0.95, and ϵ=10−5, for example. In one or more implementations, a cosine learning rate schedule is implemented, beginning with about 2000 warmup steps and gradually decaying to about 10% of the peak learning rate. In one or more other implementations, a weight decay of about le-4 and gradient clipping at about 1.0 can be applied. The dataset is tokenized using a tokenizer with a vocabulary of about 32k, built on a particular encoding algorithm. Due to smaller dataset sizes resulting from low sampling ratios, the LLMs can undergo training under an iso-compute setting to ensure equal computational time regardless of dataset size.

In one or more implementations, the LLMs can be evaluated across various benchmarks to assess their performance. These benchmarks can include Core English tasks (CoreEN), which focus on common sense reasoning, reading comprehension, and question answering. In one or more other implementations, evaluations can be conducted on tasks such as ARC Easy and Challenge (0-shot), HellaSwag (0-shot), and WinoGrande (0-shot), among others. In one or more implementations, effectiveness in mathematical reasoning can be quantified using a specific benchmark, with an 8-shot evaluation.

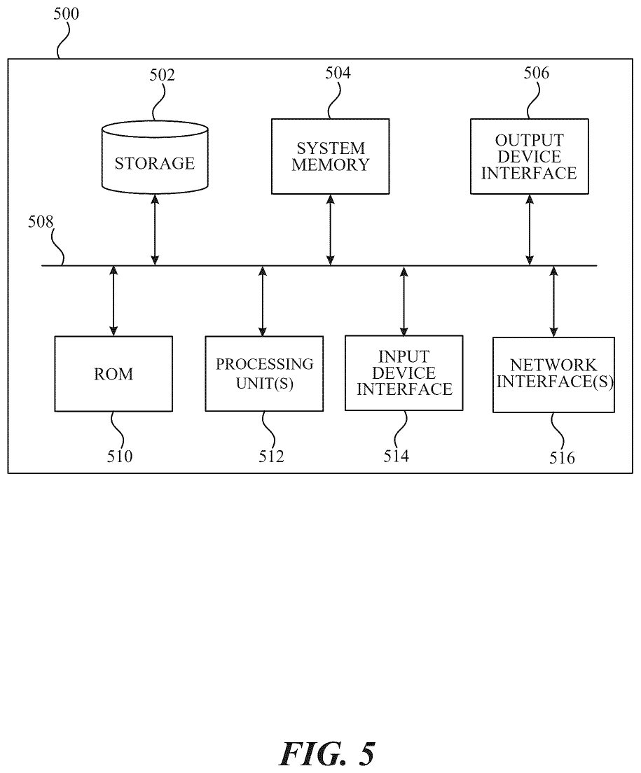

FIG. 5 illustrates an electronic system 500 with which one or more implementations of the subject technology may be implemented. The electronic system 500 can be, and/or can be a part of, the electronic device 110, and/or the server 120 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a flash drive, and its corresponding solid state drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input device interface 514 and output device interface 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes, such as the electronic device 110 shown in FIG. 1, through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
providing a plurality of data items from a first corpus of data to a first trained machine learning model;
generating, using the first trained machine learning model, a labeled dataset comprising a tag for each data item of the plurality of data items, the tag indicating a quality assessment of the data item, wherein the quality assessment indicates a quality of the data item as training data;
adjusting one or more parameters of a second trained machine learning model using tagged data items from the labeled dataset; and
generating a second corpus of data by processing one or more data items of the first corpus of data through the second trained machine learning model, the second corpus of data being a curated version of the first corpus of data.

2. The method of claim 1, further comprising training one or more neural networks with the second corpus of data to produce one or more trained machine learning models.

3. The method of claim 1, wherein generating the labeled dataset comprises determining, based on a predefined criteria, whether a data item satisfies the predefined criteria to be labeled with the tag indicating that the data item represents a positive sample or a negative sample.

4. The method of claim 1, wherein generating the labeled dataset comprises categorizing each data item of the plurality of data items as either a data item with a first textual quality or a data item with a second textual quality different from the first textual quality.

5. The method of claim 1, further comprising providing a textual prompt comprising a query to the first trained machine learning model to autonomously evaluate and select high-quality textual data from the plurality of data items.

6. The method of claim 1, wherein the quality assessment indicated in the tag comprises a score that indicates a textual quality and educational relevance of a corresponding data item.

7. The method of claim 1, wherein the labeled dataset comprises labeled results represented as pairs of data items and corresponding tags.

8. The method of claim 1, wherein the second trained machine learning model is fine-tuned using one or more of the plurality of data items associated with respective tags indicating high-quality textual samples.

9. The method of claim 1, wherein the first trained machine learning model is a large language model having a first number of parameters and the second trained machine learning model is a large language model having a second number of parameters smaller than the first number of parameters.

10. A non-transitory machine-readable medium comprising code that, when executed by a processor, causes the processor to perform operations comprising:
providing a plurality of data items from a first corpus of data to a first trained machine learning model;
generating, using the first trained machine learning model, a labeled dataset comprising a tag for each data item of the plurality of data items, the tag indicating a quality assessment of the data item, wherein the quality assessment indicates a quality of the data item as training data;
adjusting one or more parameters of a second trained machine learning model using tagged data items from the labeled dataset;
generating a second corpus of data by processing one or more data items of the first corpus of data through the second trained machine learning model, the second corpus of data being a curated version of the first corpus of data; and
training one or more neural networks with the second corpus of data to produce one or more trained machine learning models.

11. The non-transitory machine-readable medium of claim 10, wherein generating the labeled dataset comprises determining, based on a predefined criteria, whether a data item satisfies the predefined criteria to be labeled with the tag indicating that the data item represents a positive sample or a negative sample.

12. The non-transitory machine-readable medium of claim 10, wherein generating the labeled dataset comprises categorizing each data item of the plurality of data items as either a data item with a first textual quality or a data item with a second textual quality different from the first textual quality.

13. The non-transitory machine-readable medium of claim 10, wherein the operations further comprise providing a textual prompt comprising a query to the first trained machine learning model to autonomously evaluate and select high-quality textual data from the plurality of data items.

14. The non-transitory machine-readable medium of claim 10, wherein the quality assessment indicated in the tag comprises a score that indicates a textual quality and educational relevance of a corresponding data item.

15. The non-transitory machine-readable medium of claim 10, wherein the labeled dataset comprises labeled results represented as pairs of data items and corresponding tags.

16. The non-transitory machine-readable medium of claim 10, wherein the second trained machine learning model is fine-tuned using one or more of the plurality of data items associated with respective tags indicating high-quality textual samples.

17. The non-transitory machine-readable medium of claim 10, wherein the first trained machine learning model is a large language model having a first number of parameters and the second trained machine learning model is a large language model having a second number of parameters smaller than the first number of parameters.

18. A device, comprising:
a memory; and
one or more processors configured to:
provide a plurality of data items from a first corpus of data to a first trained machine learning model;
generate, using the first trained machine learning model, a labeled dataset comprising a tag for each data item of the plurality of data items, the tag indicating a quality assessment of the data item, wherein the quality assessment indicates a quality of the data item as training data;
adjust one or more parameters of a second trained machine learning model using tagged data items from the labeled dataset; and
generate a second corpus of data by processing one or more data items of the first corpus of data through the second trained machine learning model, the second corpus of data being a curated version of the first corpus of data.

19. The device of claim 18, wherein the one or more processors are further configured to train one or more neural networks with the second corpus of data to produce one or more trained machine learning models.

20. The device of claim 18, wherein the one or more processors are further configured to provide a textual prompt comprising a query to the first trained machine learning model to autonomously evaluate and select high-quality textual data from the plurality of data items.
